(19) United States
(12) Patent Application Publication
(10) Pub. No.: US 2026/0055252 A1
(43) Pub. Date: Feb. 26, 2026

(54) PROCESS FOR RECYCLING AT LEAST ONE TARGET POLYMER FROM PLASTIC WASTE CONTAINING AT LEAST ONE CONTAMINANT

(71) Applicant: FRAUNHOFER-GESELLSCHAFT ZUR FÖRDERUNG DER ANGEWANDTEN FORSCHUNG E.V., München (DE)

(72) Inventors: Swetlana WAGNER, Freising (DE); Martin SCHLUMMER, Freising (DE); Andreas MÄURER, Freising (DE); Mladen JURIC, Freising (DE)

(73) Assignee: FRAUNHOFER-GESELLSCHAFT ZUR FÖRDERUNG DER ANGEWANDTEN FORSCHUNG E.V., München (DE)

(21) Appl. No.: 19/103,353

(22) PCT Filed: Aug. 17, 2023
(86) PCT No.: PCT/EP2023/072652

§ 371 Date: Feb. 12, 2025

(30) Foreign Application Priority Data
Aug. 17, 2022 (DE) 10 2022 208 516.7

(51) Int. Cl. C08J 11/08; B29B 17/02

(52) U.S. Cl. CPC C08J 11/08; B29B 17/02; B29B 2017/0293; C08J 2309/02; C08J 2325/06; C08J 2327/06

(57) ABSTRACT

The invention relates to a process for recycling at least one target polymer from plastic waste containing at least one contaminant.

The invention relates to a method for recycling at least one target polymer from plastic waste comprising at least one contaminant.

Thermoplastic resins are particularly suitable for material recycling and are therefore well-suited for a circular economy. An increasing number of manufacturing companies are therefore asking for recycled thermoplastics or compounds with a high proportion of post-consumer recyclates.

Plastics from certain industrial waste streams, however, such as waste electrical and electronic equipment, end-of-life vehicles, and construction waste, comprise substances that hinder recycling. These are substances or impurities that are today subject to a threshold value or have now been completely banned in waste or in new products, but which used to be permitted in production in previous years and decades. Today, these are therefore often referred to as legacy additives. This situation makes the recycling of insulation materials, soft PVC or plastics from waste electrical and electronic equipment (WEEE), particularly difficult because such waste usually comprises phthalic acid esters (PVC) or brominated flame retardants (insulation materials and WEEE), which are now banned or highly regulated (Wagner and Schlummer, 2020).

For example, according to the current REACh regulation, phthalate contents exceeding 0.1% require notification and in practice are an exclusion criterion for recycling. ABS and PS (HIPS) from WEEE are often treated with brominated flame retardants. According to the current RoHS directive, it is therefore not permitted to recyclate recycle WEEE plastics comprising more than 0.1% of these. The threshold value of 500 ppm for the sum of all polybrominated diphenylethers (PBDEs) is more critical. Over the past four decades, EPS insulation materials have been treated with hexabromocyclododecane (HBCD). These days, HBCD is subject to the REACh and POP regulations and may no longer be present in recyclates (threshold value according to POP regulation 100 ppm).

The mentioned substances are very non-polar (log Kow>3), which means that they are poorly soluble in water and cannot be removed by normal cleaning steps in mechanical recycling processes. Furthermore, the slow migration of these impurities to the surface of the plastic particles prevents effective cleaning during washing processes.

One solution to the problem is to use solvent-based recycling methods that physically dissolve the target plastic, i.e., without attacking the macromolecules, and to separate them from insoluble waste components. The polymers can then be precipitated by adding a non-solvent. Contaminated legacy additives remain in solution and can be separated from the precipitated polymer.

State-of-the-art solvent-based recycling methods are able to substantially reduce the substances in the course of the recycling process. It has been shown that adding suitable precipitants to polymer solutions can effectively deplete non-polar legacy additives (EP 1 311 599 B1, EP 3 575 353 A1). JP 3752101 B2 also describes a method for separating flame retardants by precipitation in non-polar solvents. In line with the non-polar character of the impurities requiring separation, non-polar precipitants have always been used because the mixed medium of solvent and non-polar non-solvent offers good solubility for non-polar substances.

The use of polar, completely miscible precipitants for the precipitation of polymer solutions is also described in the literature. Polystyrene solutions in tetrahydrofurane (THF), a water-miscible solvent, are precipitated by adding water to spherical polystyrene particles (Higuchi et al. 2006. https://doi.org/10.1016/j.colsurfa.2005.10.042). In this case, no depletion effect on legacy additives such as phthalates or flame retardants is reported.

A mixed form of polar and non-polar precipitation is described US 2003/0119925 A1 and U.S. Pat. No. 7,056,956 B2. The authors disclose the dissolution of PVC in medium polar solvents (e.g., MEK), followed by polar water precipitation in the presence of a non-polar phase-separating solvent such as hexane, heptane or octane. For these patents, no depletion of legacy additives (such as phthalates) has been reported. It is known, however, that the technical implementation of the patents did not result in the effective removal of phthalates from soft PVC, which led to the discontinuation of the plant operation in 2019.

A similar process, the precipitation of polymer solutions using mixtures of polar and non-polar solvents, is described in EP1311599B1. In this case, the precipitation conditions actually result in a substantial separation of legacy additives from the plastic matrix, but the separation effect as observed for non-polar contaminants has been attributed to the use of non-polar solvents.

JP 3752101 B2 discloses a flame retardant separation from polymer solutions by using ultrafine filtration. In this case, the brominated flame retardant (DecaBDE) is not dissolved and can be separated by solid-liquid separation.

Alternatively or additionally, it describes how a precipitated polymer or a polymer gel can be mixed with an extractant and the extract can be separated with the impurities it comprises. The selected extraction agents here are also non-polar, as it is possible to separate non-polar impurities (EP 2 513 212 A1).

Despite the wide range of technologies available for separating legacy additives from the plastic matrix, the state of the art in science has not yet been implemented as presented. In addition to legal issues, technical and economic aspects also play a major role. The precipitation of polymer solutions from PVC or PS (also HIPS, EPS) or ABS requires large quantities of non-polar precipitants. For this purpose, as well as in the case of complex precipitation approaches (e.g., solvents, co-solvents and water), a complex and cost-intensive solvent preparation is unavoidable, which calls into question the overall economic efficiency of the processes due to the large energy requirement for thermal circulation/distillation of the large solvent and precipitant volume flows. Furthermore, the non-polar precipitants (e.g., alkanes) used in accordance with the prior art place high and costly demands on plant safety (explosion protection measures) due to their low flash points, both in terms of investment costs (specially specified equipment) and operating costs (plant operation under inert gas, including safety measures).

Another disadvantage of the prior art is the loss of quality of the recycled polymers, as has been observed so far. The halogenated polymers and/or flame retardant additives disintegrate at elevated temperatures and for extended periods of time, as already happens under typical processing extrusion conditions (usually between 220 and 300° C.). The (usually autocatalytic) molecular degradation and the resulting, predominantly acidic reaction products often have three negative consequences: Firstly, a loss of molecular weight in the target polymer, e.g., a drop in Mw of over 10%, usually over 20%, is usually observed, mostly in connection with thermo-oxidative polymer destabilisation, e.g., a drastically reduced OIT value. Secondly, the acidic reaction products cause corrosion and wear to the high-quality plant equipment. Thirdly, the resulting breakdown products contaminate the recyclates, e.g., in the case of PBDEs with highly toxic PBDD/Fs, thus making it impossible to reuse the recyclates.

The objective of this invention was to provide a recycling method that, on the one hand, enables the efficient and gentle (in the sense of low thermal and mechanical stress, so that no chemical degradation reactions occur) separation of the components and, on the other hand, can be performed easily and economically.

This objective is achieved by the recycling method with the feature of claim 1 and the polymer recyclate with the features of claim 16. The further dependent claims describe advantageous developments.

According to the invention, a method for recycling at least one target polymer from at least one plastic waste material comprising contaminants is provided, which comprises the following steps:
a) at least one solvent or mixture thereof, whose value for the hydrogen bonding strength δ_{H} of the Hansen solubility parameter is from 0.1 to 9 MPa^{0.5} and which has a water solubility of at most 20% is added to the plastic waste to selectively dissolve the at least one target polymer.
b) the dissolved target polymer is precipitated by adding water, and/or an aqueous salt solution, and/or water-soluble solvents with a Hansen solubility parameter value for hydrogen-bonding strength δ_{H} of 6 to 12 MPa^{0.5}, as a precipitant to form a target polymer gel or target polymer particles that have a higher dry matter content compared to the target polymer solution, and
c) the at least one precipitated target polymer is mechanically separated from the at least one liquid phase of solvent and precipitant in step b).

The method according to the invention is based on dissolving polymers comprising harmful substances in a medium-polarity solvent that has limited solubility in water. After the optional separation of undissolved waste components, for example by sedimentation, decantation, centrifugation or filtration, in particular using a sieve, the polymer solution is precipitated with water or an aqueous salt solution. Water may be added in doses above the solubility limit because the polymer and water interact. The resulting suspension of precipitation solution (extract) and precipitated polymer is separated and the extract, which comprises some of the impurities, is removed.

There are two options to further reduce the residual quantities of the impurities:
a) The precipitated polymer is redissolved in the solvent and again precipitated with water and/or an aqueous salt solution and/or water-soluble solvents with a hydrogen bonding strength δ_{H} value of the Hansen solubility parameter from 6 to 12 MPa^{0.5} as a precipitant.
b) Alternatively, water and/or an aqueous salt solution and/or water-soluble solvents with a Hansen solubility parameter value for the hydrogen bond strength δ_{H} of 6 to 12 MPa^{0.5} are mixed with the precipitated polymer as precipitants and blended using suitable agitation units.

In both cases, precipitated polymers are formed again and separated from the extract.

Surprisingly, the very polar precipitation leads to the removal of non-polar contaminants, favoured by the low quantities of precipitant required and the low water solubility.

The method according to the invention is characterised by the following advantages over the methods known from the prior art:
a) A significantly smaller amount of precipitant is required in step b): Instead of adding 150 to 200% of the precipitant to the solution according to the method of the prior art, the amount of precipitant is reduced to only 10-20% according to this invention. This reduces the mass flows requiring reprocessing and minimises the energy required for this.
b) The low solubility of the precipitant in the solvent enables a cost-effective and energy-efficient phase separation. This means that the water-rich precipitation phases can be easily separated from the extracts and, due to their high polarity, are practically free of any impurities (<100 ppm). These can be reused directly in the process (for subsequent extraction or precipitation steps, particularly countercurrently), which significantly reduces the high energy requirements for the operating fluid cycle that have existed up to today, despite the prior art.
c) In this respect, the reduced need for any precipitant and the phase separation not only save a great deal of process energy compared to the prior art (large amounts of precipitant are provided by energy-intensive distillation processes), but the necessary apparatus can also be realised more economically (lower throughputs required) due to the smaller mass flows.
d) Improved safety by using a precipitant that is non-flammable in operating conditions.
e) Optionally adding salt to the precipitant water increases its precipitant force (further minimising the amount of precipitant required) and improves the phase separations between precipitant and solvent on the one hand, and between the polymeric precipitant product and the liquid phase of solvent and precipitant on the other.
f) The optional addition of a basic salt and/or a salt that buffers the pH value reduces the formation of acid under time/temperature stress of the recyclate, thus leading to quality improvements (molecular weight retention) as well as a higher thermal stability (improved OIT values).

Preferably, between step a) and step b), the at least one dissolved target polymer is mechanically separated from the undissolved components of the plastic waste, wherein the mechanical separation is preferably performed using sedimentation and/or centrifugation and/or decantation and/or filtration, in particular using a sieve. In this case, a multistage separation of the non-dissolved impurities is preferred, which consists of at least coarse (>1mm) and fine (1 μm<x<=1 mm) separation.

It is particularly preferred to perform the mechanical separation of the precipitated target polymer and the liquid phase in step c) using filtration and/or sedimentation and/or centrifugation and/or by exploiting the different viscosities and/or flow properties of the precipitated target polymer and the separated liquids.

It is particularly preferable that in a further step following step c), the mixture of solvent and precipitant is separated by a first phase separation before the further thermal separation via evaporation occurs.

Preferably, in a further step d) following step c), the mixture of solvent and precipitant is separated from the at least one target polymer by evaporation, wherein the solvents and precipitants separated by evaporation are preferably separated using phase separation and again added into the method.

A preferred embodiment provides that in a further step following step c), the solvent and precipitant are separated from the mixture of solvent, precipitant and at least one contaminant by evaporation, wherein the solvents and precipitants separated by evaporation are preferably separated via phase separation and recycled into the method.

According to a further variant, it is preferred that, immediately after step b), the precipitated polymer is treated in at least one further process step with the solvent, the solvent mixture and the precipitant water, or an aqueous salt solution, or water-soluble solvents, in order to reduce the concentration of the at least one contaminant, wherein preferably the solvent or solvent mixture is added to again dissolve the precipitated polymer and then it is again precipitated with water and the liquid phases are separated from the precipitated target polymer, and/or the solvent or solvent mixture and water are added in one single step and the liquid phases are separated from the precipitated target polymer.

Preferably, the precipitation and separation of the liquid phases be performed several times in succession, wherein the liquids from the precipitation steps are used for precipitation and purification in subsequent process batches, particularly preferred as a countercurrent process.

Preferably, the at least one separated contaminant is fed to a material recycling in a further step. One preferred embodiment provides that the at least one target polymer is selected from the group consisting of
styrene copolymers, in particular acrylonitrile butadiene styrene copolymers, styrene acrylonitrile, polystyrene, HIPS, expanded polystyrene, extruded polystyrene,
polyvinyl chloride,
polyvinyl dichloride,
polyvinyl acetate,
polyvinyl alcohol,
polyvinyl butyral,
polycarbonate; and
mixtures or blends thereof.

It is preferred that the at least one contaminant is selected from the group halogenated substances, in particular fluorinated, chlorinated, brominated or mixed-halogenated aromatic hydrocarbons, or aliphatic hydrocarbons, preferably poly-chlorinated or poly-brominated aromatic hydrocarbons, flame retardants, particularly preferred chlorinated paraffins, brominated flame retardants, in particular polybrominated diphenylethers, polybrominated biphenyls, hexabromocyclododecane, tetrabromobisphenol A, brominated styrene-butadiene copolymer (PolyFR) or 1,2-bis(2,4,6-tribromophenoxy)ethane,
polycyclic aromatic hydrocarbons, such as PAH,
plasticisers, in particular phthalic acid dialkyl ester, phthalic acid alkylaryl ester, citrates, epoxidised soya bean oil (ESBO), adipic acid dialkyl ester, 1.2-cyclohexanedicarboxylic acid di-isononyl ester,
stabilisers, in particular organotin compounds, barium stearate, calcium stearate, lead stearate, lead distearate, cadmium stearate, zinc stearate,
antioxidants, in particular bisphenol-A and derivatives or sterically hindered phenols and
mixtures thereof.

It is preferred that the solvent has a value for the hydrogen bonding strength δ_{H} of the Hansen solubility parameter of at most 14 MPa^{0.5}, preferably from 0 to 9 MPa^{0.5}, particularly preferably from 0.1 to 7 MPa^{0.5}.

Furthermore, it is preferred that the solvent has a maximum water solubility of 18%, particularly preferred is a maximum of 15%, and most particularly preferred is a maximum of 10%.

Preferably, the at least one solvent is selected from the group consisting of cyclic ethers (e.g., tetrahydrofurane), aliphatic (e.g., acetone, methyl ethyl ketone) and cyclic ketones (e.g., cyclohexanone), alkyl, dialkylesters, basic ester mixtures (e.g., DBE), carbonates (e.g., propylene carbonate, ethylene carbonate, dialkyl carbonates), alkyl acetates (e.g., ethyl acetate), N-alkyl pyrrolidones (e.g., N-ethyl 2-pyrrolidone (NEP), N-methyl-2-pyrrolidone (NMP), terpenes, cymene, styrene, xylene, toluene, terpenes, (poly)alkylated benzenes, benzyl, phenyl or phenol compounds or a mixture thereof.

It is preferred that step a) be performed at a temperature of 20 to 180° C., preferably of 40 to 120° C., particularly preferably of 60 to 100° C. and/or that steps a) to b) be performed at temperatures below 100° C., preferably below 80° C., and in particular at temperatures below the flash point of the solvents used.

Preferably, salts, in particular inorganic salts, such as sulfates, nitrates, phosphates, carbonates, metal hydroxides, metal halides or metal oxides, are added to the precipitant to increase the precipitant force.

It is further preferred that the ratio of the precipitant to the mixture of the target polymer and the solvent is at most 33%, particularly preferred at most 20%, more preferred 10%, and still more particularly preferred at most 5%.

The present invention will be explained in more detail in the following examples, without any intention of restricting these to the specific embodiments shown here.

### EXAMPLE 1

### Recycling of EPS Comprising HBCD

Expanded polystyrene is dissolved in CreaSolv® FR5 (10% strength, i.e., 10% polystyrene and 90% CreaSolv® FR5) at RT up to 80° C. To do this, 60 g of EPS is mixed in a 1-litre glass beaker with 540 g CreaSolv® FR5 dissolved while stirring for 60 minutes. Dissolution can be accelerated by spraying the EPS chunks with some of the solvent used, halving the necessary dissolving time. 60 g of water is added to the dissolved polystyrene as a precipitant during the stirring until it visibly precipitates. After the polystyrene has precipitated and a gel has been been formed, the liquid supernatant is removed. To do this, the viscous gel lump (153 g) is held back with a spatula and the liquid supernatant is poured off or decanted. The liquid supernatant, consisting of 487 g of solvent and 19 g of free water phase, is separated into the two liquid phases using a separating funnel. The solvent comprising HBCD is subjected to a vacuum distillation process to gently separate the solvent and HBCD (without excessive thermal stress, which would otherwise result in the formation of unwanted polybrominated reaction products). The result is a sump comprising 2.4 g HBCD, which also still comprises almost 50% residual solvent, as well as PS oligomers and legacy additives. The purified solvent distillate (465 g) can then be reused for the next step (re-dissolving of EPS) or for the further extraction steps (re-dissolving of the precipitated EPS gel). The separated water from the separation in the separating funnel can be reused for precipitation. This can be repeated until the desired concentration of HBCD is achieved in the polystyrene.

### EXAMPLE 2

### Recycling of HIPS Comprising Brominated Flame Retardants

HIPS is dissolved in CreaSolv® FR5 (10% i.e., 10% HIPS and 90% CreaSolv® FR5) at 80° C. After the plastic has completely dissolved, water is added as a precipitant. The polymer initially precipitates in flaky form and then forms a gel as a sediment. The supernatant, consisting of solvent and water, is separated from the plastic gel via decanting. The phases of the supernatant, solvent and water, can be separated from each other using a separating funnel. In a distillation step, the brominated flame retardants are separated from the solvent. The solvent can be reused to dissolve the plastic. The separated water can be reused for precipitation. If even more brominated flame retardants are to be removed, a mixture of solvent and water in a 3:1 ratio is added to the plastic gel so that the plastic is again present in the mixture at 10%. The mixture and the plastic gel are stirred for 20 min at 80° C. The plastic gel and the mixture are then separated via decanting. Using a separating funnel, the mixture is separated again into its phases (water, solvent). The solvent is added to the distillation and separated from the brominated flame retardants. The water can be reused for the precipitation. These steps can be repeated until the desired amount of brominated flame retardants has been removed.

### EXAMPLE 3

### Recycling of ABS Comprising Brominated Flame Retardants

ABS is dissolved in a dibasic ester or a propylene carbonate (10%, i.e., 10% ABS and 90% solvent) at 80° C. Water is added to the dissolved plastic so that it turns into a gel. The supernatant, consisting of solvent and water, is separated from the gel and the individual phases (water, solvent) are separated from each other in a separating funnel. The solvent is freed of brominated flame retardants during distillation and can be reused to dissolve plastic. The separated water can be reused for precipitation. If even more brominated flame retardants are to be removed, a mixture of solvent and water in a ratio of 1:1 is added to the gel so that the plastic is again present in the mixture at 10%. The mixture of solvents, water and plastic is stirred at 80° C. The plastic is then separated from the mixture. Separating funnels are used to separate the mixture into its individual phases (solvent, water). The solvent is separated from the brominated flame retardants in a distillation step and can be reused to dissolve the plastic. Again, the water can be reused for precipitation. These steps can be repeated until the desired amount of brominated flame retardants has been removed.

### EXAMPLE 4

### Recycling of PVC Comprising DEHP

Plasticised PVC is dissolved in CreaSolv® FR3 (10%, i.e., 10% plasticised PVC and 90% CreaSolv® FR3) at 120-130° C. Water is added to the dissolved PVC until the PVC precipitates in powder form. The supernatant is separated from the precipitant using a sieve to separate polymer from solvent and precipitant. The solvent mixture is separated into solvent and precipitant using a separating funnel. In a distillation process, the solvent is freed from the plasticiser and can be reused to dissolve PVC. If even more plasticisers are to be removed, a mixture of solvent and water (20% water to solvent) is added to the PVC precipitant, which has been precipitated and separated from the supernatant, so that PVC is present at 10% in the solvent-precipitant mixture. The mixture is stirred for 10 minutes at 80° C. The PVC precipitate is then separated from the mixture. The mixture, consisting of solvent and water, is separated from each other using separating funnels. The solvent goes into the distillation process and is freed from the plasticiser. The water can be reused for the precipitation and/or the mixture. These steps can be repeated until the desired amount of plasticisers has been removed.

### EXAMPLE 5

### Recycling of Polyfr and EPS Comprising HBCD

Expanded polystyrene is dissolved in CreaSolv® FR5 (10% strength, i.e., 10% polystyrene and 90% CreaSolv® FR5) at RT up to 80° C. The poorly soluble PolyFR is separated from the solution by sedimentation or, preferably, by sedimentation in a gravitational field (centrifugation, decanter). In the process, reduction rates significantly greater than 95% are achieved for each separation step. Then, water is added to the dissolved polystyrene as a precipitant until it visibly precipitates. After precipitation of the polystyrene and formation of a gel, the supernatant is removed. The supernatant, consisting of solvent and water, is separated from the plastic gel via a separating funnel. The solvent comprising HBCD is put through a distillation process to separate the solvent and HBCD from each other. The solvent distillate can be reused for redissolving EPS. The separated water from the separation in the separating funnel can be reused for precipitation. This can be repeated until the desired concentration of HBCD is achieved in the polystyrene.

All solvents used have flash points of over 100° C. and, due to their high ignition temperatures, are categorised in temperature class T2.

1-18. (canceled)

19. A method for recycling at least one target polymer from a plastic waste comprising at least one contaminant, in which
a) at least one solvent, which has a water solubility of maximally 50%, is added to the plastic waste to selectively dissolve the at least one target polymer,
b) the at least one dissolved target polymer is precipitated by adding water, or an aqueous salt solution, or water-soluble solvents having a Hansen solubility parameter hydrogen bonding strength value δ_{H} of 6 to 12 MPa^{0.5}, as a precipitant, to form a target polymer gel or target polymer particles that have a higher dry matter content compared to the target polymer solution, and
c) the at least one precipitated target polymer is mechanically separated from the at least one liquid phase consisting of solvent and precipitant in step b).

20. The method according to claim 19, wherein the at least one solvent in
a) has a hydrogen bond strength δ_{H} of the Hansen solubility parameter from 0 to 9 MPa_{0.5}.

21. The method according to claim 19, wherein, between step a) and step b), the at least one dissolved target polymer is mechanically separated from undissolved components of the plastic waste.

22. The method according to claim 21, wherein the mechanical separation is performed via sedimentation, decantation, centrifugation, or filtration, or a combination thereof, and/or the mechanical separation of the precipitated target polymer and liquid phase in step c) is performed by filtration and/or sedimentation and/or centrifugation and/or by exploiting different viscosities and/or flow properties of the precipitated target polymer and the separated liquids and/or by exploiting the different viscosities and/or flow properties of the precipitated target polymer and the separated liquids.

23. The method according to claim 19, wherein in a further step d) that follows step c), the mixture of solvents and precipitants is separated from the at least one target polymer by evaporation.

24. The method according to claim 23, wherein the mixture of solvents and precipitants separated by evaporation are separated via phase separation and resupplied into the method.

25. The method according to claim 19, wherein, in a further step following step c), the solvent and precipitant are separated from the mixture of solvent, precipitant, and at least one contaminant by evaporation.

26. The method according to claim 25, wherein the solvents and precipitants separated by evaporation are separated by phase separation and resupplied into the method.

27. The method according to claim 19, wherein, immediately after step b) and/or c), the precipitated polymer is treated in at least one further process step with a solvent, the solvent mixture, and the precipitant water in order to reduce the concentration of the at least one contaminant.

28. The method according to claim 19, wherein the precipitation and separation of the liquid phases are performed several times in succession, and liquids from the precipitation steps are utilized for precipitation and purification in subsequent process steps.

29. The method according to claim 19, wherein, in a further step, the at least one separated contaminant is fed to a material recycling process.

30. The method according to claim 19, wherein the at least one target polymer is selected from the group consisting of styrene copolymers, polystyrene, HIPS, expanded polystyrene, extruded polystyrene, polyvinyl chloride, polyvinyl dichloride, polyvinyl acetate, polyvinyl alcohol, polyvinyl butyral, and polycarbonate.

31. The method according to claim 19, wherein the at least one contaminant is selected from the group consisting of halogenated substances.

32. The method according to claim 19, wherein the at least one contaminant is selected from the group consisting of flame retardants, chlorinated paraffins, brominated flame retardants, polybrominated diphenylethers, polybrominated biphenyls, hexabromocyclododecane, tetrabromobisphenol A, brominated styrene-butadiene copolymer (PolyFR), 1,2-bis(2,4,6-tribromophenoxy)ethane, polycyclic aromatic hydrocarbons, plasticisers, stabilisers, and antioxidants.

33. The method according to claim 31, wherein the halogenated substances are selected from the group consisting of fluorinated, chlorinated, brominated, and mixed-halogenated aromatic hydrocarbons.

34. The method according to claim 32, wherein
the flame retardants are selected from the group consisting of chlorinated paraffins, brominated flame retardants, polybrominated diphenylethers, polybrominated biphenyls, hexabromocyclododecane, tetrabromobisphenol A, brominated styrene-butadiene copolymer (PolyFR), and 1,2-bis(2,4,6-tribromophenoxy)ethane,
the polycyclic aromatic hydrocarbon is PAH,
the plasticisers are selected from the group consisting of phthalic acid dialkyl ester, phthalic acid alkylaryl ester, citrates, epoxidised soy bean oil (ESBO), adipic acid dialkyl ester, and 1.2-cyclohexanedicarboxylic acid di-isononyl ester,
the stabilisers are selected from the group consisting of organotin compounds, barium stearate, calcium stearate, lead stearate, lead distearate, cadmium stearate, and zinc stearate, and
the antioxidants are selected from the group consisting of bisphenol-A and derivatives and sterically hindered phenols.

35. The method according to claim 20, wherein the solvent has a value for the hydrogen bonding strength δ_{H} of the Hansen solubility parameter of 1 to 6 MPa^{0.5}.

36. The method according to claim 20, wherein the solvent has a maximum water solubility of 15%.

37. The method according to claim 19, wherein the at least one solvent is selected from the group consisting of cyclic ethers, aliphatic ketones, cyclic ketones, basic ester mixtures, carbonates, alkyl acetates, N-alkyl pyrrolidones, cymene, styrene, and water.

38. The method according to claim 19, wherein step a) is performed at a temperature of 20 to 180° C., and/or steps a) to b) are performed at temperatures below 100° C.

39. The method according to claim 19, wherein salts are added to the precipitant to increase precipitation force.

40. The method according to claim 19, wherein the ratio of precipitant to the mixture of target polymer and solvent is at most 1:5.

41. A polymer recyclate comprising at least one polymer selected from the group consisting of styrene copolymers, polyvinyl chloride, polyvinyl dichloride, polyvinyl acetate, polyvinyl alcohol, polyvinyl butyral, and polycarbonate, wherein a content of contaminant or contaminants is in the range of 0.5 to 1000 ppm.

42. The polymer recyclate according to claim 41, wherein the content of contaminant or contaminants is in the range of 1 to 200 ppm and/or the content of solvent and/or precipitant is in the range from 1 ppm to 1000 ppm.

43. The polymer recyclate according to claim 41, wherein the contaminant or contaminants is/are selected from the group consisting of halogenated substances, flame retardants, polycyclic aromatic hydrocarbons, plasticisers, stabilisers, antioxidants, and mixtures thereof.
